(19) United States
(12) Patent Application Publication
(10) Pub. No.: US 2009/0305536 A1
(43) Pub. Date: Dec. 10, 2009

(54) ELECTRICAL CONNECTOR HAVING A LEVER ASSIST MATING MECHANISM

(75) Inventor: Galen M. Martin, Camp Hill, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Berwyn, PA (US)

(21) Appl. No.: 12/134,379

(22) Filed: Jun. 6, 2008

(51) Int. Cl. H01R 13/62

(52) U.S. Cl. 439/157

(57) ABSTRACT

An electrical connector is disclosed that includes a receptacle connector and a plug connector with a lever to assist mating the receptacle and plug connectors. The lever rotates within a slot formed between the receptacle and plug connectors. The lever is configured to permit an operator to mate and unmate the receptacle and plug connectors with a reduced mating and unmating force provided by the mechanical advantage of the lever. The lever may include an optional snap feature for securely engaging the lever in a closed position.

### FIELD OF THE INVENTION

The present invention relates generally to an electrical connector. More specifically, the present invention relates to an electrical connector including a plug connector and a receptacle connector having a lever mechanism to apply a mechanically assisted mating and un-mating force.

### BACKGROUND OF THE INVENTION

Electrical connectors typically include a plug connector having a plug housing containing pin contacts mated to a receptacle connector having a receptacle housing containing socket contacts. The plug housing and the receptacle housing are physically engaged, which physically and electrically connects the pin and socket contacts, forming an electrical connection. In many applications, a large number of pin and corresponding socket contacts are necessary, resulting in a large normal force required to mate the plug and receptacle connectors.

Additionally, this type of connector is typically sealed and may include both signal terminals and power terminals to be included in a single assembly. This arrangement may further increase the force necessary to mate the electrical connectors forming the assembly.

Furthermore, this type of connector may be used in cases where one of the connectors is fixed and accessibility by the other movable connector is limited. This type of arrangement often exists, for example, in the automotive industry. In order to save space, the movable connector housing may be mostly received in the fixed connector housing, causing the disengagement of the moveable connector from the fixed housing to be difficult.

In order to resolve these problems, cam slides have been used to increase the force available to mate and disengage two electrical connectors. For example, an electrical connector using a cam slide to apply mating force is disclosed in U.S. Pat. No. 6,200,164 B1, incorporated herein by reference in its entirety. The cam slide is arranged on the movable connector and must be displaced in a direction transverse to the direction of engagement during operation. However, this arrangement requires additional space transverse to the mating direction for operation, and may require high operational forces to complete the assisted mating engagement.

Therefore, there is an unmet need to provide a connector having a mating assist mechanism for facilitating mating to another electrical connector having minimal space and applied force requirements.

### SUMMARY OF THE INVENTION

One embodiment of the present invention relates to an electrical connector including a receptacle connector and a plug connector. The receptacle connector includes a receptacle housing including an insertion portion, at least one cam follower disposed on the insertion portion, and a fixed housing. The plug connector includes a plug housing, a lever attached to the plug housing, an inner housing disposed within the plug housing, a terminal position assurance member disposed around a portion of the inner housing, and a wire cover attached to the plug housing. The lever is configured to engage the at least one cam follower when rotated to either assist in inserting or in removing the insertion portion of the receptacle connector from the plug housing.

Another embodiment of the present invention relates to a method of mating an electrical connector including the steps of providing a receptacle connector including a receptacle housing including an insertion portion, at least one cam follower disposed on the insertion portion, and a fixed housing, and providing a plug connector including a plug housing, a lever attached to the plug housing in a open position, an inner housing disposed within the plug housing, a terminal position assurance member disposed around a portion of the inner housing, and a wire cover attached to the plug housing. The lever is configured to engage at least one cam follower to either assist in inserting or removing the insertion portion of the receptacle connector from the plug housing when rotated. The method further includes partially inserting the insertion portion of the receptacle connector into the plug housing to a partial inserted position, and fully inserting the insertion portion of the receptacle connector into the plug housing by rotating the lever from an open position to a closed position thereby assisting the mating force by a mechanical force resulting from the camming action between the lever and the at least one cam follower to form a fully mated electrical connector.

Further aspects of the method and system are disclosed herein. The features as discussed above, as well as other features and advantages of the present invention will be appreciated and understood by those skilled in the art from the following detailed description and drawings.

### BRIEF DESCRIPTION OF THE DRAWINGS

FIG. 1 illustrates an exemplary mated electrical connector according to the invention.

FIG. 2 illustrates the electrical connector of FIG. 1 unmated.

FIG. 3 illustrates an exploded perspective view of an exemplary plug connector.

FIG. 4 illustrates a cross sectional view of the electrical connector of FIG. 1 taken along line 5-5 with the connector partially unmated and with the lever in the open position.

FIG. 5 illustrates a cross sectional view of the electrical connector of FIG. 1 taken along line 5-5.

Wherever possible, the same reference numbers will be used throughout the drawings to refer to the same or like parts.

### DETAILED DESCRIPTION OF THE INVENTION

The present invention now will be described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art.

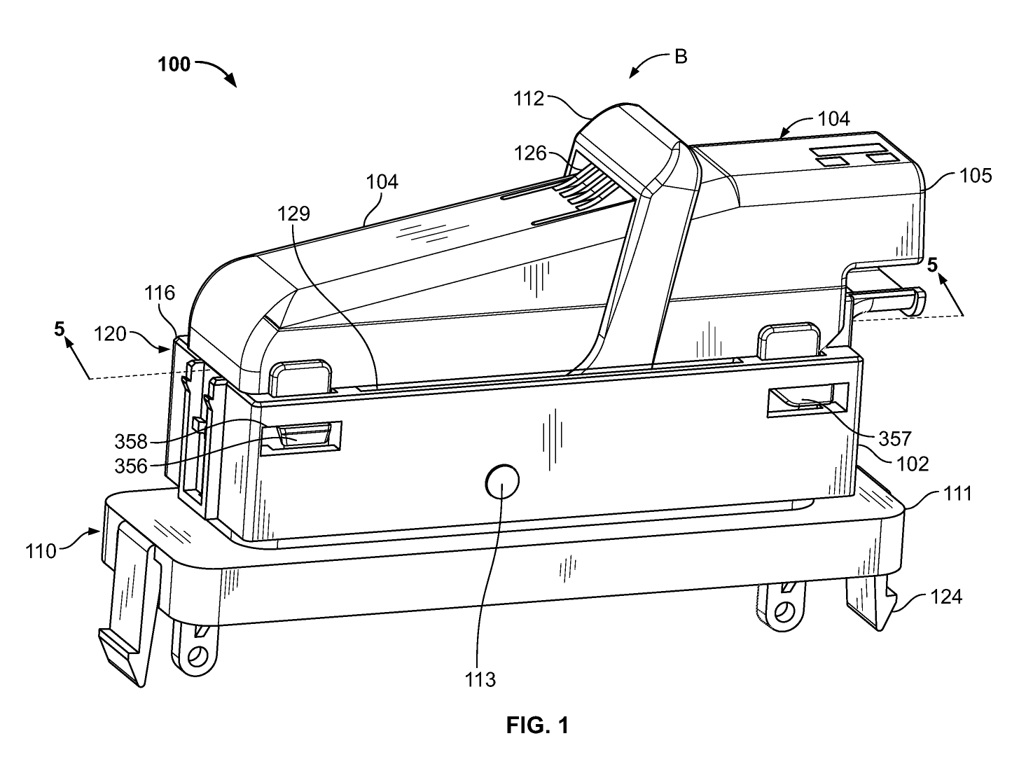

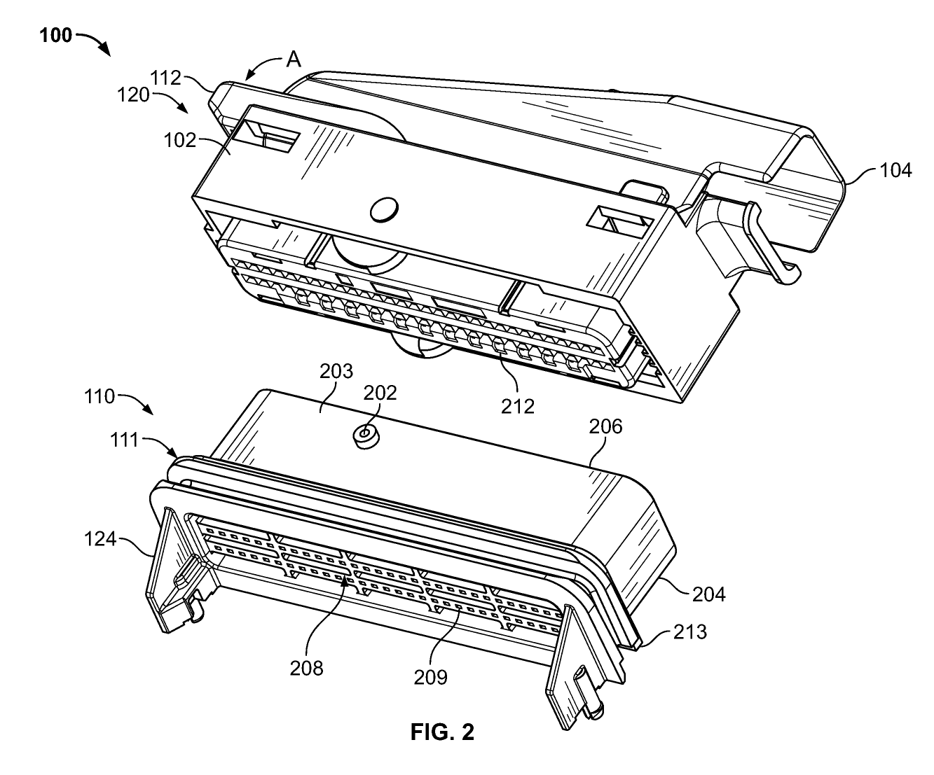

FIGS. 1 and 2 show an exemplary embodiment of an electrical connector 100 according to the invention. The electrical connector is shown mated in FIG. 1 and unmated in FIG. 2. The electrical connector 100 includes a receptacle connector 110 and a plug connector 120. In one embodiment, the receptacle connector 110 may be a printed circuit board header. The plug connector 120 includes a lever 112. The lever 112 provides additional force to mate and unmate the plug connector 120 and the receptacle connector 110 as will be described below.

As shown in FIG. 2, the receptacle connector 110 includes a receptacle housing 111. The receptacle housing 111 includes a receptacle housing insertion portion 204 and a receptacle fixed housing 213. The receptacle fixed housing 213 includes a receptacle contact support structure 208 disposed therein. The receptacle contact support structure 208 includes contact slots 209 configured to receive and secure a plurality of receptacle contacts (not shown). The plurality of receptacle contacts may include pins or tails to attach the plurality of receptacle contacts to electrical pads, traces or other conductive pathways on a substrate (not shown). The substrate may be a printed circuit board (PCB). In one embodiment, the plurality of receptacle contacts may be a plurality of pin contacts. In another embodiment, the plurality of receptacle contacts may be a plurality of blade, socket, spring or other electrical contacts.

The receptacle fixed housing 213 further includes snap latches 124 for attachment to a substrate (not shown). In another embodiment, the fixed housing 213 may include additional and/or other attachment and alignment structures to securely assemble the receptacle connector 110 to the substrate.

The receptacle housing insertion portion 204 includes a receptacle housing insertion portion outer surface 203 having cam followers 202 disposed thereon (a cam follower is present, but not shown, on the opposite side of the receptacle housing insertion portion 204).

As further shown in FIGS. 1 and 2, the plug connector 120 includes a plug housing 102, a lever 112 pivotally affixed to the plug housing 102, and a wire cover 104 attached to the plug housing 102. The wire cover 104 includes an open portion 105 configured to receive a plurality of plug conductors (not shown). The plurality of plug conductors may be a plurality of plug conductor wires. In another embodiment, the plurality of plug conductors are provided in at least one plug cable (not shown).

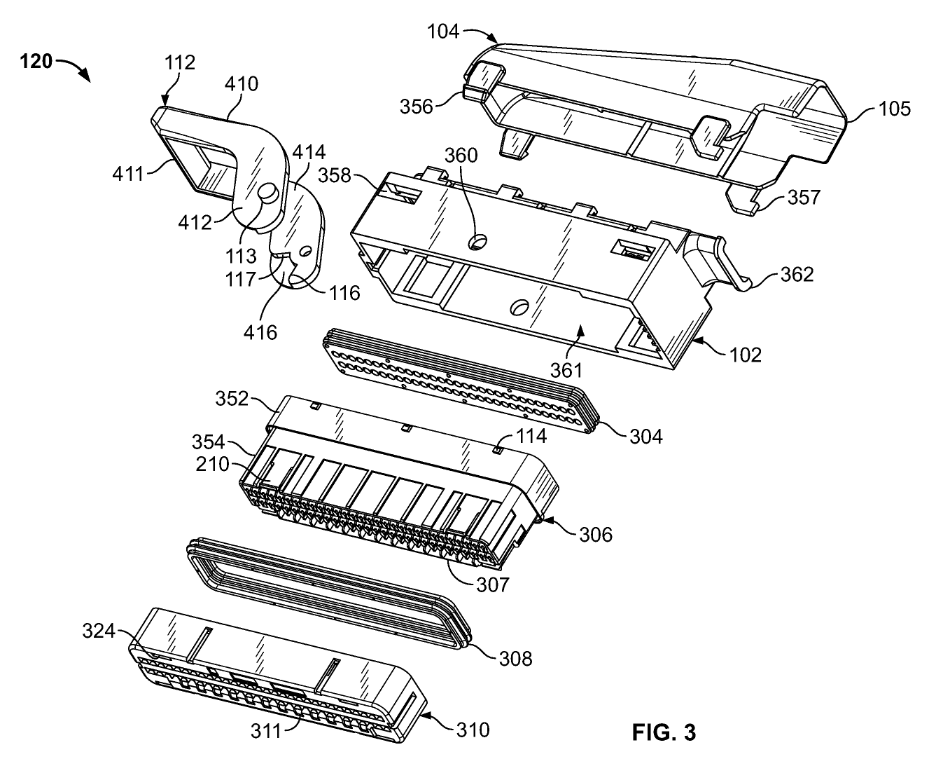

The plug connector 120 is shown in greater detail in FIG. 3. As can be seen in FIG. 3, the plug connector 120 further includes plug housing 102, an inner housing 306, a wire seal 304 disposed within the inner housing 306, a mating seal 308, and a terminal position assurance (TPA) member 310 having a plurality of contact guide openings 311 for receiving the plurality of receptacle contacts (not shown).

The wire seal 304 includes a plurality of plug conductor through-holes for receiving the plurality of plug conductors (not shown), which are correspondingly terminated to the plurality of plug contacts (not shown) disposed within the inner housing 306. The wire seal 304 provides an environmental seal between the plurality of plug conductors (not shown) and the inner housing 306. The wire seal 304 may be formed of an elastomeric material such as rubber, an elastomeric polymer or other similar material.

The inner housing 306 includes an inner housing base portion 352 and a plug contact support portion 354. The inner housing base portion 352 includes tabs 114 for securely assembling the inner housing 306 within the plug housing 102. In another embodiment, the inner housing 306 may contain protrusions, recesses or other fastening features configured to be engaged by corresponding assembly features within the plug housing 102 to securely assemble the inner housing 306 thereto.

The inner housing plug contact support portion 354 is configured to contain a plurality of plug contacts (not shown) therein. The inner housing plug contact support portion 354 includes cavities 307 that provide access to the plurality of plug contacts by the corresponding plurality of receptacle contacts (not shown) of the receptacle connector 110. The plurality of plug contacts may be a plurality of socket contacts configured to mate with the plurality of receptacle contacts (not shown). In another embodiment, the plurality of plug contacts may be pins, blades, sockets, springs or other electrical contacts that correspondingly mate with the plurality of receptacle contacts. The inner housing plug contact support portion includes tabs 210.

The mating seal 308 is disposed around the plug contact support portion 354 and abuts the inner housing base portion 352. The mating seal 304 provides an environmental seal between the inner housing 306 and the TPA member 310. The mating seal 308 may be formed of an elastomeric material such as rubber, an elastomeric polymer or other similar material.

The inner housing plug contact support portion 354 of the inner housing 306 is received within the TPA member 310. The TPA member 310 is configured to assure that the plurality of plug contacts (not shown) are properly received in the inner housing 306, as would be appreciated by one of ordinary skill in the art. The TPA member 310 includes openings 311 configured to receive the plurality of receptacle contacts (not shown). The TPA member 310 further includes slots 324 for receiving tabs 210 of the inner housing 306 for securely assembling the TPA member 310 thereto. In another embodiment, the TPA member 310 may have protrusions, recesses, slots or other fastener structure corresponding to engaging fastener structure in the inner housing 306 for securely assembling the TPA member 310 thereto.

In another embodiment, the inner housing 306 may be omitted and the structure thereof may be included in the plug housing 102. In another embodiment, the wire seal 304 may be omitted. In another embodiment, the mating seal 308 may be omitted. In another embodiment, the inner housing 306 and the TPA member 310 may be combined into a single member (not shown) not requiring the mating seal 308.

The lever 112 includes side arms 410. The lever 112 further includes a cross member 411 interconnecting the side arms 410. Side arms 410 include an outer surface 412 and an inner surface 414. The outer surface 412 includes pins 113 disposed thereon (a pins is present, but not shown, on the opposite outer surface). The inner surface includes a recess 416. The recess 416 includes a lever insertion engaging surface 116 and a lever ejection engaging surface 117. In this exemplary embodiment, the recess 416 includes an outer surface 412. In another embodiment, the recess 416 may have no outer surface 412.

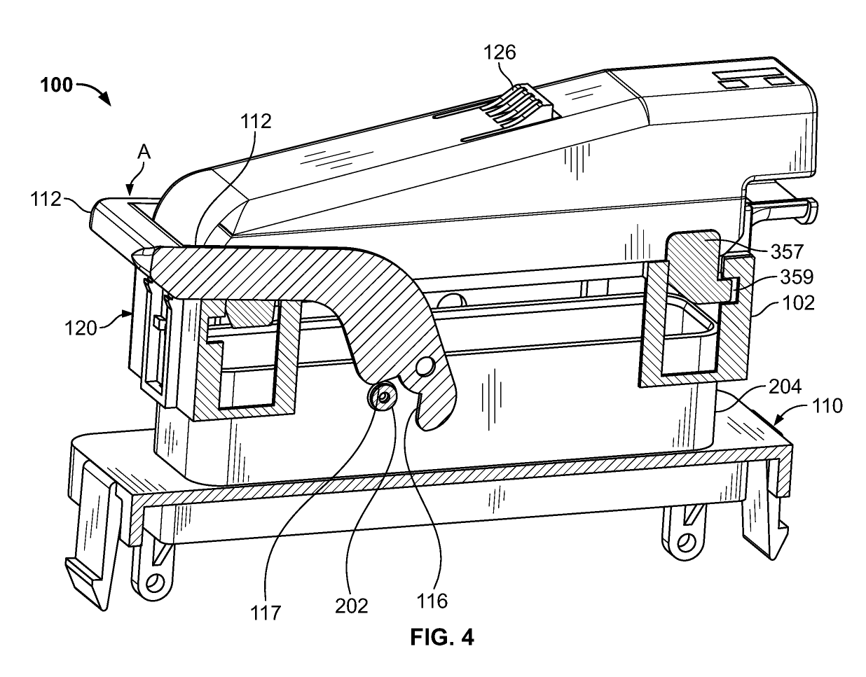

As can be further seen in FIG. 3, the plug housing 102 includes first recesses 358, second recesses 359 (FIG. 4), lever pin holes 360, an inner cavity 361, and a plug conductor receiver portion 362. The first recesses 358 are configured to receive tabs 356 of the wire cover 104 to securely assemble the wire cover 104 to the plug housing 102. The second recesses 359 are configured to receive protrusions 357 of the wire cover 104 to further securely assemble the wire cover to the plug housing 102. In another embodiment, the plug housing 102 and wire cover 104 may be provided with any combination of corresponding mating tabs, pins, recesses, slots or other fastening features to securely assemble the wire cover 104 to the plug housing 102. The plug housing 102 further includes lever pin holes 360 for receiving pins 113 of the lever 112.

As can be seen in FIGS. 1, 2 and 3, the plug housing 102, wire cover 104 and lever 112 are configured so when assembled, the lever 112 is partially disposed within a slot 129 defined by and formed between the plug housing 102 and wire cover 104. Additionally, the pins 113 are received in the lever pin holes 360, and the plug housing 102 and wire cover 104 are configured, to permit the lever 112 to rotate about the lever pin holes 360 from an open position A, shown in FIG. 2, to a closed position B, shown in FIG. 1.

As can be seen in FIG. 4, the wire cover 104 includes a snap feature 126. The snap feature 126 is configured to resiliently depress into the wire cover 104 to permit the lever 112 to pass thereover until the cross member 411 is securely engaged by the snap feature in closed position B. In one embodiment, the snap feature 126 may make an audible sound to an operator when engaging the lever 112. The snap feature 126 is configured to inform the installer that the electrical connector 100 is fully mated by the audible sound, the secure position of the lever 112, or both. When the electrical connector 100 is in mated position and the lever 112 is engaged by the snap feature 126, the lever 112 can be released from the snap feature 126 by depressing the snap feature 126 into the wire cover 104 and rotating the lever 112 towards open position A (FIG. 2) thereby permitting the plug connector 120 and the receptacle connector 110 to be unmated. In another embodiment, the snap feature 126 may be omitted. In yet another embodiment, another securing feature, such as a wire clip, wire fastener or other similar component, may additionally be used to secure the lever 112 in a closed position. In another embodiment, the snap feature 126 may be omitted and another securing feature may be used.

The receptacle connector 110 and the plug connector 120 are mated by receiving the receptacle housing insertion portion 204 into the plug housing 102. The receptacle housing insertion portion 204 is shown partially inserted into the plug housing 102 in FIG. 4. FIG. 4 is a cross sectional view of FIG. 1 taken along line 5-5 with the receptacle housing insertion portion 204 partially removed from the plug housing 102 to a partial insertion position. As can be seen in FIG. 4, the receptacle housing insertion portion 204 of the receptacle connector 110 has been partially received into the plug housing 102 to where the lever ejection engaging surface 117 of the lever 112 has contacted the cam follower 202. If the receptacle housing insertion portion 204 is further received, the lever 112 will be rotated away from the open position A (FIG. 1). In one embodiment, the further insertion and subsequent rotation away from open position A alerts an operator to the further insertion of the receptacle housing insertion portion 204 into the plug housing 102.

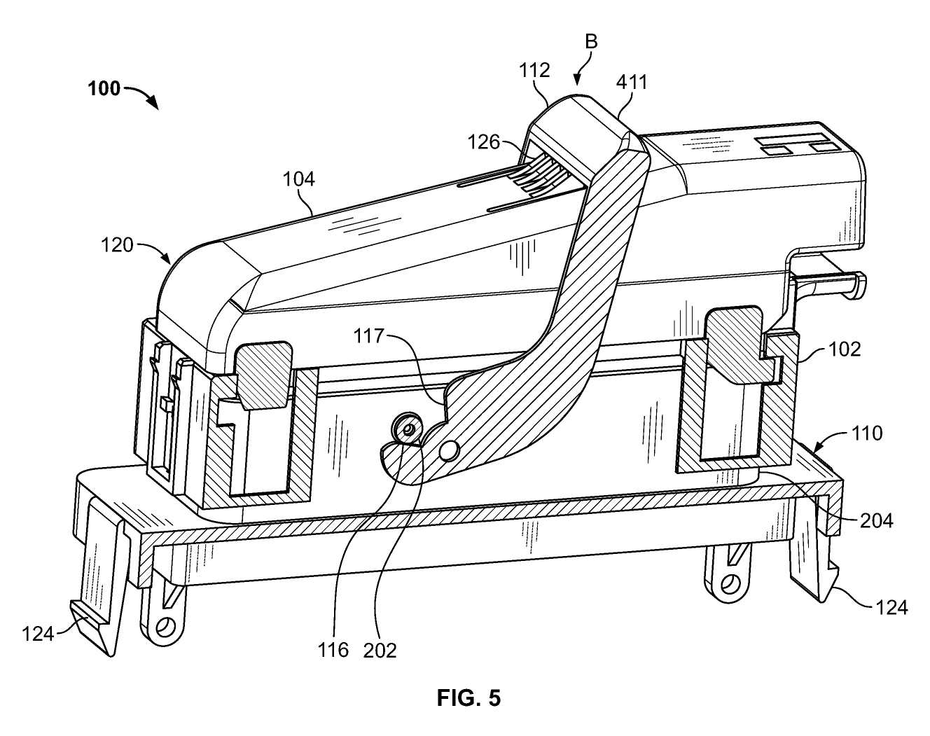

At the position where the receptacle housing insertion portion 204 has been manually inserted into the plug housing 102 to contact the lever ejection engaging surface 117 and the cam follower 202, the lever 112 may be rotated from open position A to closed position B (FIG. 5). Rotating the lever 112 from open position A (FIG. 4) to closed position B brings the lever insertion engaging surface 116 into contact with the cam follower 202 to provide a mechanical assist to fully insert the receptacle housing insertion portion 204 into the plug housing 102. The mechanical assist permits an operator to mate the receptacle connector and plug connector with the mechanical advantage provided by the lever, thus allowing the operator to use less force than would be required without the lever to mate the receptacle connector and plug connector.

FIG. 5 shows the cross sectional view of the receptacle connector 110 of Fig. fully inserted into the plug connector 120. As can be seen in FIG. 5, the lever 112 has been rotated to position B, which has correspondingly engaged the lever insertion engaging surface 116 and the cam follower 202 to fully receive the receptacle housing insertion portion 204 of the receptacle connector 110 into the plug connector housing. The lever 112 provides additional force to mate the plug connector 120 and the receptacle connector 110. In particular, the lever 112 may assist mating the plug connector 120 and the receptacle connector 110 when the electrical connector 100 contains a large number of contacts.

The electrical connector 100 may be unmated by rotating the lever 112 from closed position B as shown in FIG. 5 towards open position A (FIG. 4). Rotating the lever 112 from closed position B towards open position A engages the lever ejection engaging surface 117 and the cam follower 202. Further rotation of the lever 112 towards open position A causes the lever 112 to force the plug connector 120 away from the receptacle connector 110 until the receptacle connector housing 102 is partially received in the plug housing 102 as shown in FIG. 5. Thus the rotation of the lever 112 from closed position B to open position A provides an unmating mechanical assist. At the point where the lever 112 is rotated to the open position A, the plug connector 120 may be further manually unmated from the receptacle connector 110 to completely unmated the plug connector from the receptacle connector. The mechanical assist permits an operator to unmate the receptacle connector and plug connector with the mechanical advantage provided by the lever, thus allowing the operator to use less force than would be required without the lever to unmate the receptacle connector and plug connector.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electrical connector, comprising:
a receptacle connector comprising a receptacle housing comprising an insertion portion and a cam follower disposed on an outer surface of the insertion portion; and
a plug connector comprising a plug housing and a lever attached to the plug housing;
wherein the lever comprises arms comprising an outer surface and an inner surface; and
wherein the lever is configured to rotate within a slot disposed between and defined by the insertion portion and the plug housing to engage the a cam follower to either assist in inserting or assist in removing the insertion portion of the receptacle connector from the plug housing when rotated while the inner surface of the lever arms are in contact with the receptacle connector outer surface;
wherein the lever further includes a recess having a lever insertion engaging surface configured to engage the cam follower when the receptacle connector is partially inserted within the plug connector and the lever is rotated to assist in mating the receptacle connector and plug connector;
and wherein the lever insertion engaging surface engages the cam follower without sliding the cam follower over the lever insertion engaging surface.

2. The electrical connector of claim 1, wherein the outer surface of the lever has pins disposed thereupon to rotatably attach the lever to the plug housing.

3. (canceled)

4. The electrical connector of claim 1, wherein the recess is disposed on the inner surface.

5. The electrical connector of claim 2, wherein the lever further includes a recess having a lever ejection engaging surface configured to engage the cam follower when the receptacle connector is inserted within the plug connector and the lever is rotated to assist in unmating the receptacle and the plug connector.

6. The electrical connector of claim 5, wherein the recess is disposed on the inner surface.

7. The electrical connector of claim 1, wherein the receptacle housing further includes a fixed housing configured to attach the receptacle connector to a substrate.

8. The electrical connector of claim 1, wherein the plug connector further comprises a wire cover attached to the plug housing.

9. The electrical connector of claim 8, wherein the wire cover comprises a snap feature configured to securely engage the lever in a closed position when the receptacle connector and plug connector are mated.

10. The electrical connector in claim 1, wherein the receptacle connector further comprises a plurality of receptacle contacts disposed within the receptacle housing.

11. The electrical connector of claim 1, wherein the wire cover comprises a snap feature configured to releasably engage the lever.

12. A method of mating an electrical connector, comprising:
providing a receptacle connector comprising a receptacle housing comprising an insertion portion having a cam follower disposed on an outer surface thereof; and
providing a plug connector comprising a plug housing and a lever attached to the plug housing in a open position;
partially inserting the insertion portion of the receptacle connector into the plug housing to a partial inserted position to form a slot between the insertion portion and the plug housing; and
rotating the lever from the open position to a closed position;
wherein the lever comprises arms comprising an outer surface and an inner surface; and
whereby the lever engages the cam follower to assist in inserting the insertion portion of the receptacle connector into the plug housing when rotated from the open position to the closed position while the inner surface of the lever arms are in contact with the receptacle connector outer surface
wherein the lever further includes a recess having a lever insertion engaging surface configured that engages the cam follower when the receptacle connector is partially inserted within the plug connector and the lever is rotated to assist in mating the receptacle connector and plug connector; and
wherein the lever insertion engaging surface engages the cam follower without sliding the cam follower over the lever insertion engaging surface.

13. The method of claim 12, further comprising:
rotating the lever from the closed position to the open position;
whereby the lever engages the cam follower to assist in removing the insertion portion of the receptacle connector form the plug housing when rotated from the closed position to the open position.

14. The method of claim 12, whereby inserting the insertion portion past partial insertion with the lever in the closed position causes the lever to rotate away from the closed position.

15. The method of claim 12, further comprising:
securing the lever in the closed position

16. The method of claim 12, further comprising rotating the lever to a closed position to secure the lever to the plug housing by engaging a lever cross member with a snap feature located on a wire cover assembled to the plug housing.

17. The method of claim 15, wherein the lever is secured in a closed position by rotating the lever to engage a lever cross member with a snap feature located on a wire cover assembled to the plug housing.
